(19) United States
(12) Patent Application Publication
(10) Pub. No.: US 2009/0109605 A1
(43) Pub. Date: Apr. 30, 2009

(54) Portable electric power distribution device and methods of use

(76) Inventor: James E. Blake, Jupiter, FL (US)

Correspondence Address: DAVID J. WILSON, 61 BELCHER CIRCLE, MILTON, MA, 02186, US

(21) Appl. No.: 11/978,512

(22) Filed: Oct. 29, 2007

(51) Int. Cl. H02B 1/21

(52) U.S. Cl. 361/625

(57) ABSTRACT

In one aspect, the invention relates to a portable device for the distribution of electrical power in one or more interchangeable, predefined configurations and methods of use.

### BACKGROUND OF INVENTION

Portable electrical power is used in many situations from construction sites, to concerts, festivals and mobile carnivals. In such situations power from a source such as a portable generator or commercial source must be distributed to numerous devices that require electricity to operate. Although these devices may run on, for example, the same voltages, they often have vastly different requirements for amperage. Because of these differences, power often must be distributed to the various devices via power distribution “boxes” or other devices. However, these prior art devices do not lend themselves to flexibility as the users needs changes over the short or long term such as, for example, when new equipment requiring a different amperage to operate is purchased or more equipment is need at a particular job site. In these and other situations the user must purchase new power distribution “boxes” as their needs change.

Therefore, what is needed is a power distribution device that allows the user the flexibility to inexpensively change the distribution of power at a job site as the user's needs change.

### SUMMARY OF INVENTION

In one aspect, the invention relates to a portable device for the distribution of electrical power in one or more interchangeable, predefined configurations. The power distribution device of the present invention comprises, in one embodiment, a housing having one or more bays within said housing. Electrical power is delivered to the power distribution device of the present invention from any suitable power source such as a generator or commercial power supply. The electrical power is distributed to one or more power distribution blocks, with one power distribution block for each bay of the device of the present invention. This is, for example, a first predefined configuration. In this way, the incoming power may be divided such that a predetermined amperage can be directed to each bay on the device. Within each bay a user may place an interchangeable tray or rack designed to distribute power in a second predefined configuration as detailed below.

In a preferred embodiment, the housing also comprises a front, back, side, floor and roof panels. In another embodiment, one or more doors are located in the front, back and side panels for access to internal components. In yet another embodiment, the doors may have locks or other security devices to prevent unauthorized entry.

In yet another embodiment, the doors of the present invention may have openings through which the switches of the device (e.g., breaker switches) may extend. With this design, the switches can be used without having to open the doors of the device. The doors of the device may be opened, e.g., to service or rewire the device. In yet another embodiment, the rear or back panel (or any other panel) of the device may have a double door (i.e., a door-behind-a-door arrangement). With this arrangement, the outside door or first door, would block access to the device. The inside or second door would, for example, have the switches of the breakers extending through the door for easy access but prevent access into the inside of the device thereby preventing, for example, inexperienced persons from accessing the wiring of the device. In another embodiment, the device does not comprise a bottom panel or the bottom panel has slots or other perforations for cooling. Likewise, the bottom panel may be made of a screen, a screen-like material, a mesh or a mesh-like material.

In the present invention, bays are defined as areas in the housing where racks or trays can be placed. The bays typically have rails or other suitable supports at the side of the bay to support a rack or tray or they can have a complete floor to support the rack or tray. The racks or trays of the present invention, in one embodiment, slide into the bay. In another embodiment, the racks or trays have wheels for ease of insertion. Once placed in the bay, they can be locked in position by pins or insert and locking handles, cam-locks or other suitable locking devices, for example, which are known in the art. In a preferred embodiment, the locking device used to lock the tray/rack in position can be locked with a key to prevent unwanted removal of the tray/rack.

The racks (or trays) of the present invention are made and sized to slid into the bays of the housing. The racks are designed to have a predetermined configuration for power output. For example, the racks may have any combination of sockets equal to but not exceeding the amperage going to the bay. Thus, a rack may have, for example, two 100 amp sockets (outputs), four fifty amp sockets or twenty 10-amp sockets for a bay that has 200 amps delivered to the bay. The racks interconnect with the power source of the bay with, for example, male/female or female/male connectors or other suitable devices known in the art. In another embodiment, the sockets of the rack may be interchanged so that the user may remove, for example, a fifty amp socket and replace it with two twenty-five amp sockets. Numerous other suitable interchangeable combinations are also possible and can be practiced based on the teachings of the present specification.

The electrical power distribution device of the present invention comprises a primary breaker switch for shutting off power to the entire device. The device also comprises secondary breaker switches for each bay useful for shutting off power to each bay individually if, for example, a tray or rack needs to be changed. In one embodiment, power enters the device through one or more plugs or other connection devices. Power is then conducted (via wire or other conductive material, for example) to the primary circuit breaker. From the primary circuit breaker power is conducted to each bay or insertable tray or rack where the power is divided for delivery to each of the bays. In one embodiment, the amount of amperage that each bay receives is equal to each other bay. In another embodiment, the amount of amperage that each bay receives is different from one or more of the other bays of the device. Each bay has a secondary breaker switch suitable for shutting of power to that bay. Additionally, the sockets or groups of sockets on each tray may also have breakers to control (shut-off/start) power to each socket or groups of sockets.

Each bay is designed to accept a rack. Racks of the present invention are interchangeable with other racks. Racks may be made to handle the specific amperage of a particular bay. However, each rack may divide the power entering the bay into various secondary predetermined configurations. For example, if one bay is powered with 200 amperage (amps), the racks suitable for use in that bay would accept in input of 200 amps. However, any one of the those racks may divide the power up in different configurations. For example, one rack may divide the power into four 50 amp sockets, two fifty amp sockets and twenty-five amp sockets or forty-five amp sockets. The racks of the present invention are not limited to any particular predetermined power configuration. Each socket may, but need not have a switch for turning power on and off to that socket.

The trays are inserted into each bay and the connections on the back of the tray or rack meet with the connections at the back of the bay. The connections at the back of the bay, in one embodiment, have power cut off to them when the tray or rack is removed by, for example, tripping the breaker switch for that bay. This helps to prevent accidents or shorts from happening by not permitting the flow of current to the connectors at the back of the bay when a tray or rack is not in place. Suitable power connectors are known in the art and available commercially.

The racks or trays are held in place by, for example, cam-locks at the front of the trays. The cam-locks, may, for example, also work to push the tray further into the bay and thereby ensure that a solid contact has been made between the tray or rack and the connections at the back of the bay. An interlock in conjunction with the cam-locks would, for example, trip the secondary circuit breakers to the bays to cut power to the bays when the trays are removed. The interlocks may work, for example, similarly to the circuit breaker test trip switch found on bathroom style power sockets. Once the trays are inserted into the bay, the interlock may serve to reset the secondary breaker or, in another embodiment, it may be required that the secondary breaker be reset manually. The connectors between the trays or racks and the connectors at the back of the bays may comprise tabs, wires, plug-in or push-in (i.e., male/female-type or female/male type) connectors. The present invention is not limited to any particular type or connector and any suitable connector known in the art is contemplated by the present invention.

In another embodiment, the portable power distribution device of the present invention is constructed to conform to applicable electrical standards. Suitable components, manufactures, suppliers and standards may be found by referencing sources in the industry such as, for example, the National Electrical Manufacturers Association (www.nema.org) or Underwriters Laboratory (www.ul.com) and sources referenced therein. These sources are not intended to be limiting but rather are intended to illustrate the knowledge available in the art at the time of the conception of the present invention in regards to the safe construction of electrical devices as well as components commercially available to the inventor of the present invention.

In a non-limiting embodiment, the power input into the portable power distribution box of the present invention has a power input of 600 amperes. The power is then divided into bays wherein the power to each bay is of 100 or 200 hundred amperes each. Each tray can then divide the incoming power to sockets wherein each socket has a rating of 5, 10 20, 25, 50, 100 or 200 amperes. In one embodiment, it is contemplated that he input power source is rated between 50 and 2400 amperes. In another embodiment, it is contemplated that the power delivered to any one bay is between 50 and 600 amperes. In yet another embodiment, it is contemplated that the power delivered to any one socket of a tray or rack is between 5 and 600 amperes.

The housing of the present invention, in another embodiment, comprises at least two wheels to aid the user in moving the device. If two wheels are present, they are located at the base of the housing on one side with the wheel axles in line with each other. If four wheels are present then the wheels are located at each corner. In the four-wheeled version of the device, the two leading wheels, the two trailing wheels or all four wheels may pivot or swivel to aid the user in steering the device. The user may then grasp the housing of a handle provided on said housing to push or pull the device to a desired location. If the device has two wheels, the user may pivot the device onto the two wheels and then push or pull the device to a desired location. On devices with two wheels, the other end of the device may be held off of the ground with feet or other stationary means. The feet or other stationary means also keeps the device from moving or rolling when the user does not what or need the device moved. In devices with four wheels, one or more wheels may have wheel locks to prevent the device from moving when not desired. Wheel locks may also be present on two wheeled units. Wheel locks are, for example, friction devices that prevent the wheels from turning (rolling) when the wheel locks are used or activated. Examples of suitable wheel lock devices are found on handcarts, pull wagons, etc., and are well known in the art.

The present invention, in another embodiment, also comprises materials and methods for covering and protecting the device of the present invention. A cover conceals the device from persons who may damage the device or become injured on it. It also protects the device from inclement weather. In one embodiment, the housing comprises retractable rods designed to support a tent-like structure that can surround the device housing. In a preferred embodiment, the supports are located on the top panel of the housing. One support is located at each corner of the device housing and positioned so that when extended from the retracted position it extends from the corner of the housing essentially horizontal to the ground. The support can be extended when needed and can be locked in the retracted or extended position by, for example, a bolt, hitch clips, cotter pins or the like. Additionally, one or more supports may extend from the top of the housing oriented essentially vertical to the ground. The support can be, for example, a rod that is positioned into a receptacle located on the top (or roof) of the housing. If one support is used then the receptacle would be located essentially at the center of the housing roof. In a preferred embodiment, the covering is a tent or tent-like device that attaches to the support rods of the housing.

In one embodiment, the present invention contemplates a portable device for distributing electrical power in one or more interchangeable predefined configurations, said device comprising: a housing, said housing comprising a roof and sides, two or more wheels, a handle, a means for preventing the device from rolling when movement of the device is not desired, one or more doors located at the front, back and/or sides of the housing and a plurality of bays within said housing; wherein said electrical power is delivered to said bays in one or more first predefined configurations and wherein within said bays, interchangeable racks suitable for the distribution of electrical power in one or more second predefined configurations are interchangeably inserted.

In another embodiment, the present invention contemplates that the portable device for distributing electrical power in one or more interchangeable predefined configurations additionally comprises a primary breaker. In another embodiment, the present invention contemplates that the portable device for distributing electrical power in one or more interchangeable predefined configurations additionally comprises a secondary breaker for each bay. In another embodiment, the present invention contemplates that the portable device for distributing electrical power in one or more interchangeable predefined configurations additionally comprises a means (e.g., a socket or sockets) for connecting to an electrical power source. In yet another embodiment, the present invention contemplates that the portable device for distributing electrical power in one or more interchangeable predefined configurations is connected to an electrical power source ranging from about 50 to 2400 amps. In still yet another embodiment, the present invention contemplates that the portable device for distributing electrical power in one or more interchangeable predefined configurations comprises from about 1 to 7 bays. In still yet another embodiment, the present invention contemplates that the portable device for distributing electrical power in one or more interchangeable predefined configurations comprises a first predefined power configuration to said bays is from about 25 to 600 amps. In still yet another embodiment, the present invention contemplates that the portable device for distributing electrical power in one or more interchangeable predefined configurations comprises one or more sockets of about 5 to 600 amps each to a maximum amperage equal to that of the first predefined power configuration of the bay wherein said rack is inserted. In still yet another embodiment, the present invention contemplates that the portable device for distributing electrical power in one or more interchangeable predefined configurations comprises sockets wherein said sockets are interchangeable individually or in groups. In still yet another embodiment, the present invention contemplates that the portable device for distributing electrical power in one or more interchangeable predefined configurations comprises a covering sized to fit over the device concealing it from view and wherein said covering is selected from a group consisting of being designed to attached to said device or being designed to be free standing. In still yet another embodiment, the present invention contemplates that the portable device for distributing electrical power in one or more interchangeable predefined configurations comprises a means for the trays or racks to interface with electrical power from the housing comprises one or more of tabs, wires or plug-in connectors and that the trays or racks are locked into said bays with cam-locks. In still yet another embodiment, the present invention contemplates that the one or more doors located at one or more of the front, back and/or sides of the housing comprise a first door and a second door, said second door located behind said first door and covered by said first door when said first door is closed.

In one embodiment, the present invention contemplates a portable device for distributing electrical power in one or more interchangeable predefined configurations, said device comprising: a housing, said housing comprising a roof and sides, two or more wheels, a handle, a means for preventing the device from rolling when movement of the device is not desired, one or more doors located at the front, back and/or sides of the housing and a plurality of bays within said housing; wherein said electrical power is delivered to said bays in one or more first predefined configurations and wherein within said bays, interchangeable racks suitable for the distribution of electrical power in one or more second predefined configurations are interchangeably inserted; wherein said racks are locked into said bays with cam-locks; wherein said means for the racks to interface with electrical power from the housing comprises one or more of tabs, wires, plug-in or push-in connectors; and wherein at least one socket in one tray/rack is interchangeable with one or more other sockets.

In another embodiment, the present invention contemplates that the portable device for distributing electrical power in one or more interchangeable predefined configurations comprises a means for the racks to interface with electrical power from the housing comprises plug-in or push-in connectors. In yet another embodiment, the present invention contemplates that the portable device for distributing electrical power in one or more interchangeable predefined configurations comprises a covering sized to fit over the device concealing it from view and wherein said covering is selected from a group consisting of being designed to attached to said device or being designed to be free standing of said.

In one embodiment, the present invention contemplates a method of distributing electrical power in predefined interchangeable configurations, comprising: providing: i) the device of the present invention, ii) a power source and, iii) one or more electrical devices wherein each electrical device is in need of electrical power of a known amperage and wherein the power needed by the each of the one or more electrical devices is the same or different from the other electrical devices; configuring the device of present invention in such a way to provide the amount of electrical power needed by each electrical device to each electrical device; connecting the device of present invention to the power source and to the one or electrical devices in need of electrical power; and provide electrical power to the device of present invention through the power source.

In another embodiment, the present invention contemplates that the device of the present invention and methods of use of the present invention comprise user instructions and/or service manuals and/or repair guides.

Other features and advantages of the invention will be apparent from the following description.

### BRIEF DESCRIPTION OF DRAWINGS

FIG. 1 shows a front view of one embodiment of the present invention with the door closed.

FIG. 2 shows the front view of one embodiment of the present invention with the door opened.

FIG. 3 shows back view of one embodiment of the present invention with the door opened. An exemplification of the visible wiring is also shown.

FIG. 4 shows a side view of one embodiment of the present invention with the door opened.

FIG. 5 shows a top view of one embodiment of the present invention with the support arms for the cover shown.

FIG. 6 shows a ¾ front view of one embodiment of the present invention with one of the interchangeable racks removed.

FIG. 7 shows a wiring diagram of showing a schematic of the distribution of power from the feed lines into the device to the connectors that interface with the trays or racks. Power configurations are exemplary only.

FIG. 8 shows a wiring diagram of one exemplary tray or rack.

FIG. 9 shows a wiring diagram of a second exemplary tray or rack.

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

While the invention has been described with respect to a limited number of embodiments, those skilled in the art, having benefit of this disclosure, will appreciate that other embodiments can be devised which do not depart from the scope of the invention as disclosed herein.

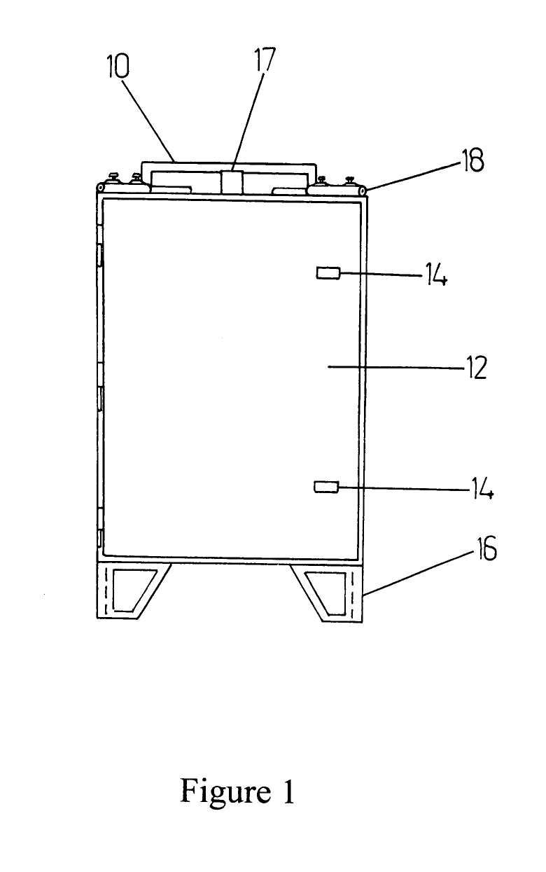

FIG. 1 shows one embodiment of the device of the present invention with the door closed. Shown in this exemplary embodiment are the handle 10, the door 12, the locking devices for the door 14, feet 16, a support for a post useful in supporting a covering over the top of the device of the present invention 17, and four supports useful for holding a covering way from the sides of the device of the present invention 18.

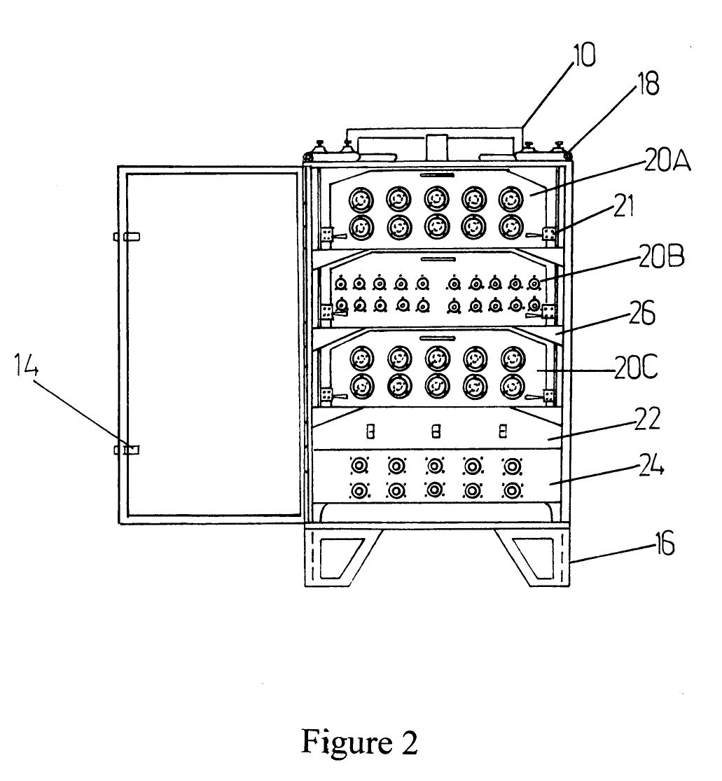

FIG. 2 shows one embodiment of the device of the present invention with the front door open. Visible in this exemplary embodiment are the locking devices for the door 14, the feet 16, three removable/interchangeable trays/racks suitable for plugging in electrical devices into the present invention, 20A, 20B, 20C. The device is not limited to any particular number of removable/interchangeable trays/racks. In other embodiments of the present invention the number of trays/racks may number, for example, from 1 to 7 (or more). The trays/racks of the present invention are held in place by, for example, cam-locks 21 with one cam-lock on each front edge of the tray/rack. The cam-locks of the present invention also may be useful in pushing the tray/rack further into the bay thereby ensuring that the electrical contacts/connectors at the rear of the tray/rack make secure contact with the appropriate electrical contacts/connectors in the rear of the bay. The trays/racks of the present invention are slid into the bay on supports 26, and rest on the supports when positioned in the bay. Power is inputted into the device on panel 24, where input connectors are present for equipment ground, system ground and one power input for each available rack or tray. Also shown are feed-through, pass-through or output plugs suitable for connecting, for example, a second device of the present invention or other electrical device.

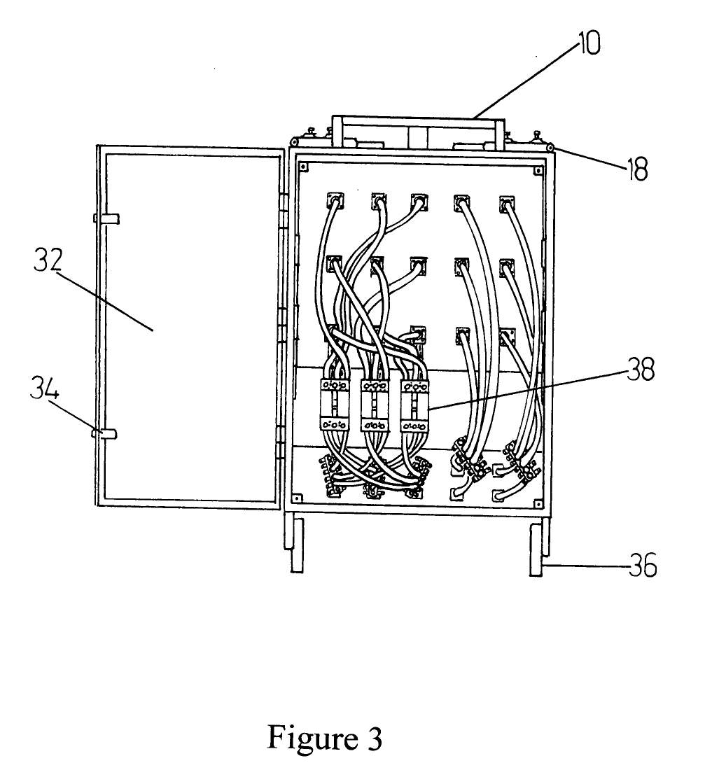

FIG. 3 shows one embodiment of the rear panel of the device of the present invention. Shown in this exemplary embodiment are the handle 10, corner supports for a cover 18, the rear door 32, locking devices for the rear door 34, secondary circuit breakers 38 for each tray/rack and wheels 36. Also visible is one embodiment of the wiring of the device. The three sets of wires on the left of the figure are the power conducting wires. The two sets of wires on the right are the tray/rack equipment and system grounds.

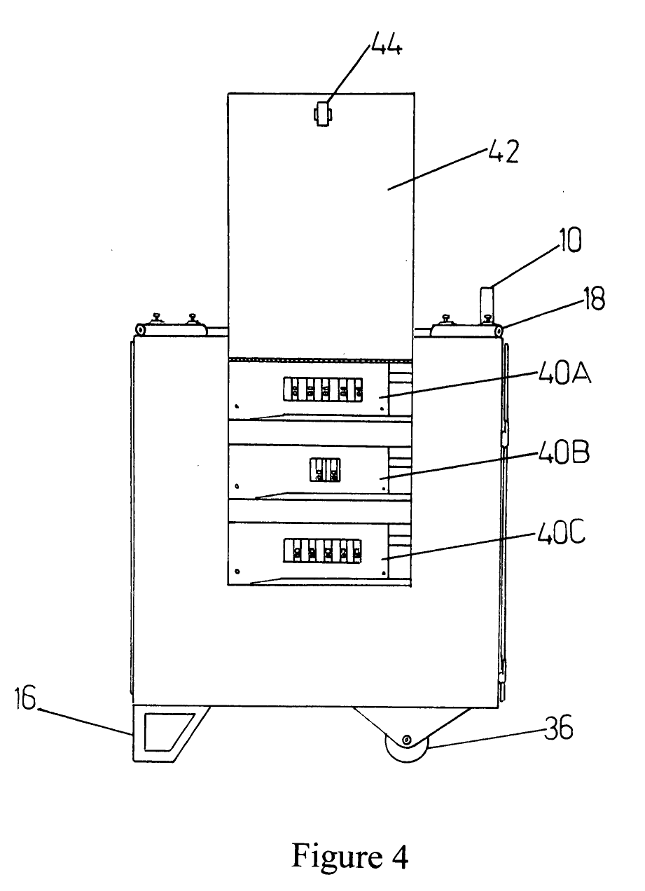

FIG. 4 shows one embodiment of a side view of the device of the present invention. Visible in this exemplary embodiment are the door 42, the locking device for the door 44, the handle 10, corner supports 18 for a cover for the device, one of two feet 16, one of two wheels 36 and the sides of each tray/rack (40A, 40B and 40C) showing circuit breakers for specific electrical sockets in the respective trays/racks.

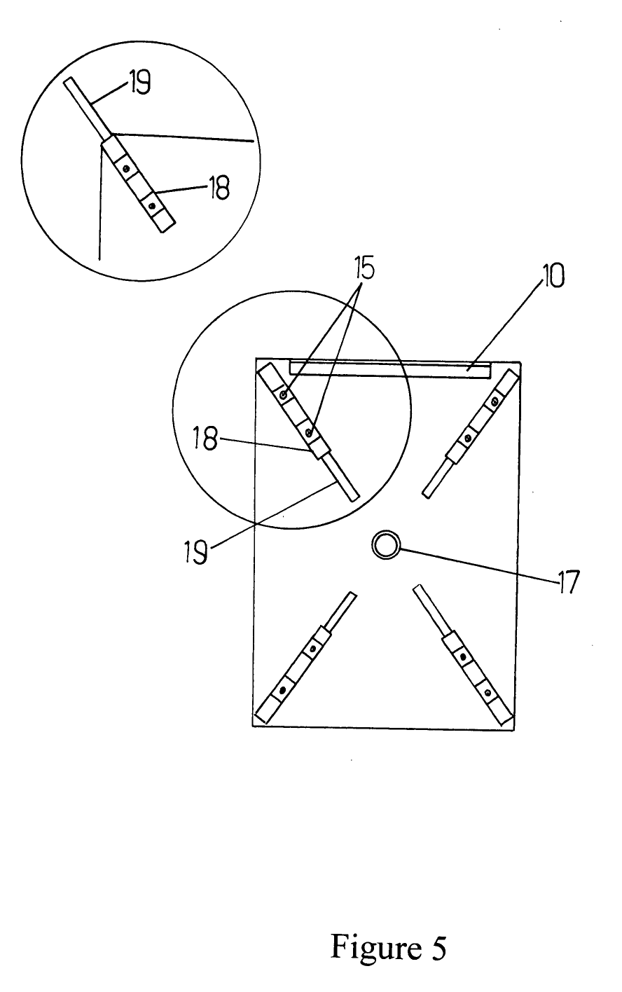

FIG. 5 shows one embodiment of a top view of the device of the present invention. Shown in this exemplary embodiment are four corner supports for a cover 18, a center support for a post for supporting a cover 17, the handle 10, extendable support rods 19, and thumb screws or other suitable devices 15 for holding the extendable support rods in position. The insert picture shows an extendable rod 19 of a corner support 18 of the present invention in the extended position.

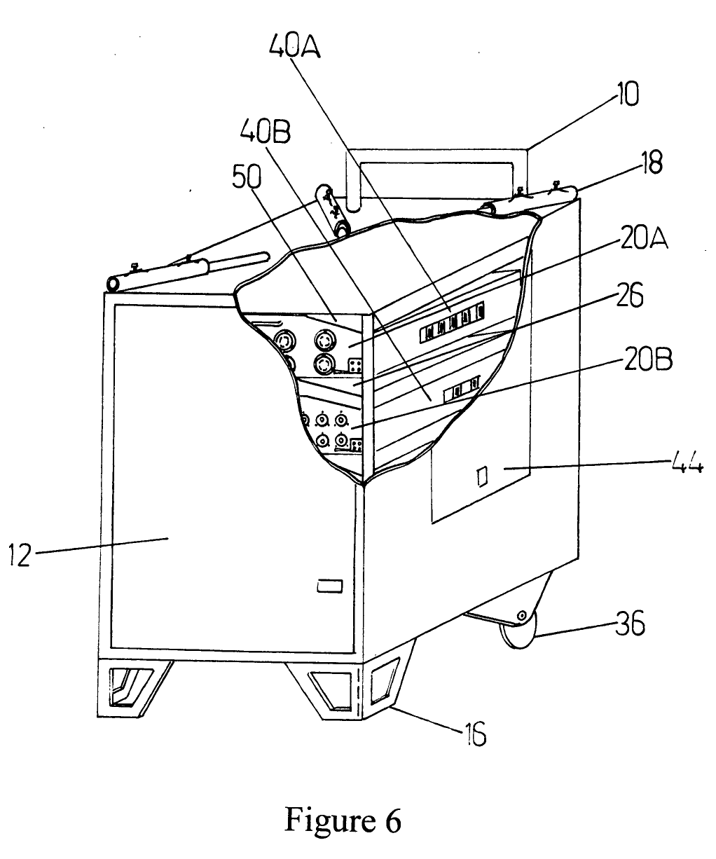

FIG. 6 shows a ¾ cut-away view of the device of the present invention. Shown in this exemplary embodiment are the front door 12, the side door 44, the feet 16, one of two wheels 36, trays/racks 20A and 20B, one tray/rack support 26, and circuit breaker panels 40A and 40B on trays/racks 20A and 20B, respectively. Number 50 shows the top of tray/rack 20A which may be closed, opened or partially closed or opened depending on the configuration chosen by the builder or user.

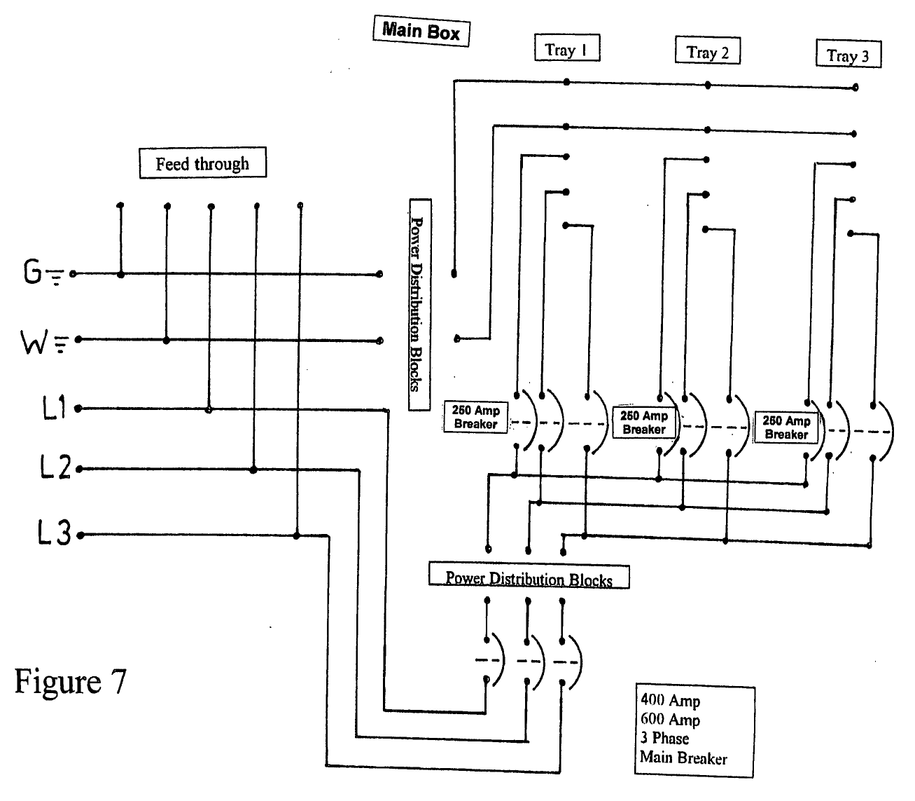

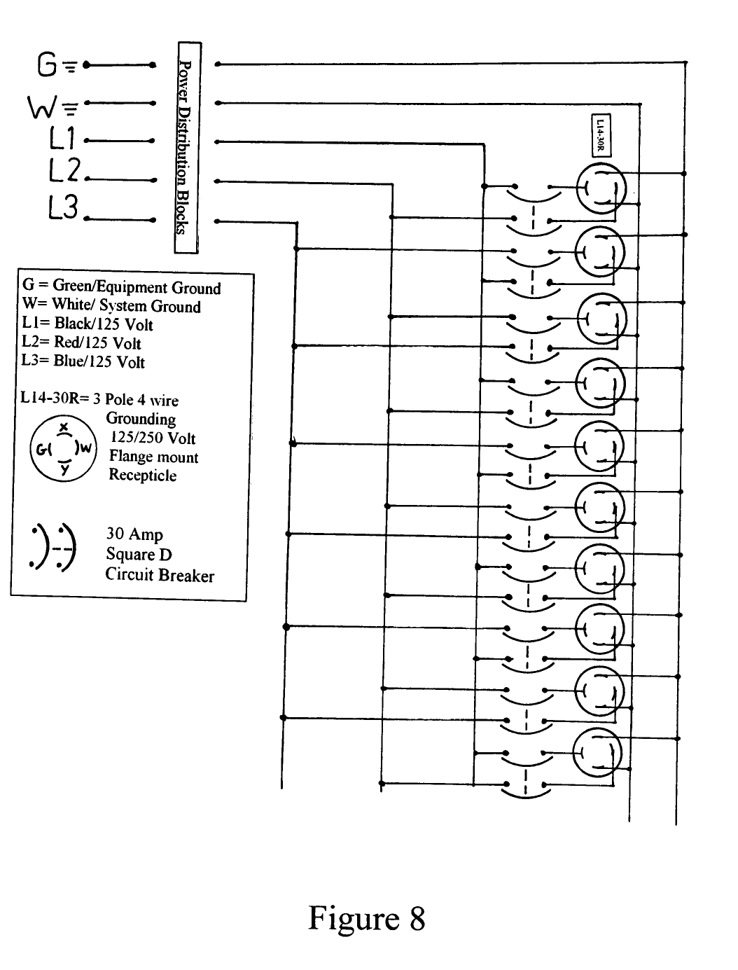

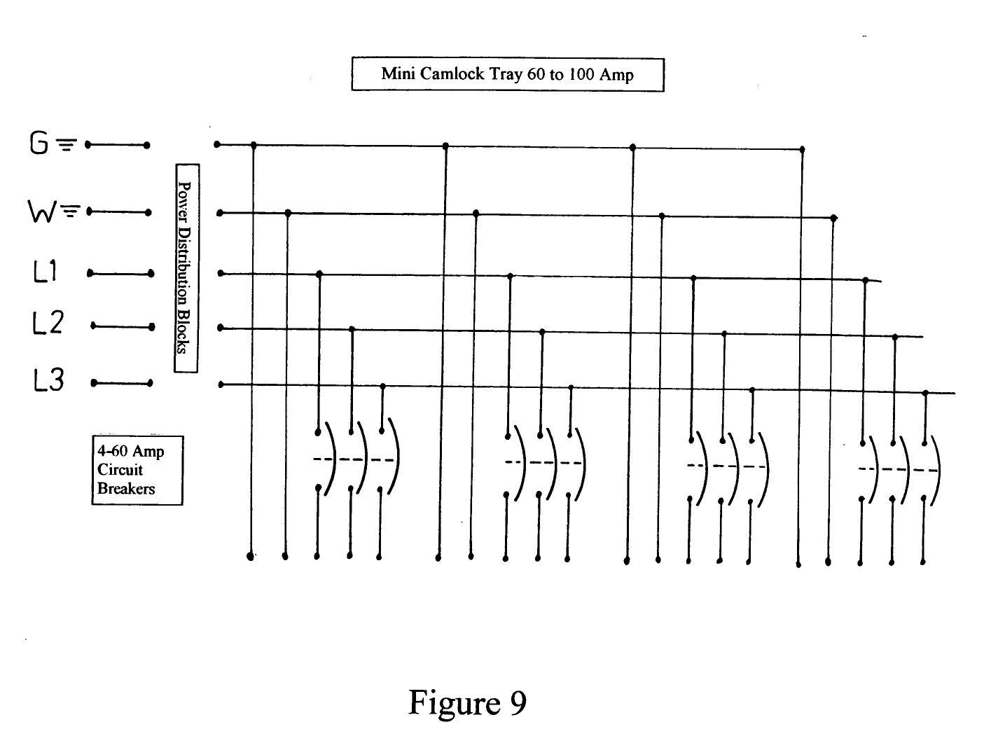

FIGS. 7, 8 and 9 show exemplary wiring diagrams for the present invention. Conventional symbols and nomenclature known in the art are used.

What is claimed is:

1. A portable device for distributing electrical power in one or more interchangeable predefined configurations, said device comprising:
a. a housing, said housing comprising a roof and sides, two or more wheels, a handle, a means for preventing the device from rolling when movement of the device is not desired, one or more doors located at the front, back and/or sides of the housing and a plurality of bays within said housing;
b. wherein said electrical power is delivered to said bays in one or more first predefined configurations and wherein within said bays, interchangeable racks suitable for the distribution of electrical power in one or more second predefined configurations are interchangeably inserted.

2. The device of claim 1, wherein said device additionally comprises a primary breaker.

3. The device of claim 1, wherein said device additionally comprises a secondary breaker for each bay.

4. The device of claim 1, wherein said device additionally comprises a means for connecting to an electrical power source.

5. The device of claim 4, wherein said electrical power source is from about 50 to 2400 amps.

6. The device of claim 1, wherein the number of bays number from 1 to 7.

7. The device of claim 1, wherein the first predefined power configuration to said bays is from about 25 to 600 amps.

8. The device of claim 1, wherein the second predefined power configuration of said racks comprises one or more sockets of about 5 to 600 amps each to a maximum amperage equal to that of the first predefined power configuration of the bay wherein said rack is inserted.

9. The device of claim 8, wherein said sockets are interchangeable individually or in groups.

10. The device of claim 1, where said device also comprises a covering sized to fit over the device concealing it from view and wherein said covering is selected from a group consisting of being designed to attached to said device or being designed to be free standing.

11. The device of claim 1, wherein said means for the racks to interface with electrical power from the housing comprises one or more of tabs, wires or plug-in connectors.

12. The device of claim 1, wherein said racks are locked into said bays with cam-locks.

13. The device of claim 1, wherein said means for the racks to interface with electrical power from the housing comprises plug-in or push-in connectors.

14. The device of claim 1, wherein the one or more doors located at one or more of the front, back and/or sides of the housing comprise a first door and a second door, said second door located behind said first door and covered by said first door when said first door is closed.

15. A portable device for distributing electrical power in one or more interchangeable predefined configurations, said device comprising:
a. a housing, said housing comprising a roof and sides, two or more wheels, a handle, a means for preventing the device from rolling when movement of the device is not desired, one or more doors located at the front, back and/or sides of the housing and a plurality of bays within said housing;
b. wherein said electrical power is delivered to said bays in one or more first predefined configurations and wherein within said bays, interchangeable racks suitable for the distribution of electrical power in one or more second predefined configurations are interchangeably inserted;
c. wherein said racks are locked into said bays with cam-locks;
d. wherein said means for the racks to interface with electrical power from the housing comprises one or more of tabs, wires, plug-in or push-in connectors; and
e. wherein at least one socket in one tray/rack is interchangeable with one or more other sockets.

16. The device of claim 15, wherein said means for the racks to interface with electrical power from the housing comprises plug-in or push-in connectors.

17. The device of claim 15, wherein the one or more doors located at one or more of the front, back and/or sides of the housing comprise a first door and a second door, said second door located behind said first door and covered by said first door when said first door is closed.

18. The device of claim 15, where said device also comprises a covering sized to fit over the device concealing it from view and wherein said covering is selected from a group consisting of being designed to attached to said device or being designed to be free standing of said.

19. A method of distributing electrical power in predefined interchangeable configurations, comprising:
a. providing: i) the device of claim 1, ii) a power source and, iii) one or more electrical devices wherein each electrical device is in need of electrical power of a known amperage and wherein the power needed by the each of the one or more electrical devices is the same or different from the other electrical devices;
b. configuring the device of claim 1 in such a way to provide the amount of electrical power needed by each electrical device to each electrical device;
c. connecting the device of claim 1 to the power source and to the one or electrical devices in need of electrical power; and
d. provide electrical power to the device of claim 1 through the power source.
